(19) United States
(12) Patent Application Publication
(10) Pub. No.: US 2013/0309428 A1
(43) Pub. Date: Nov. 21, 2013

(54) TEMPORARY LINING

(71) Applicant: Tim Morgan, (US)

(72) Inventors: Tim MORGAN, Seattle, WA (US); Jay Pierce, Mukilteo, WA (US)

(73) Assignee: Tim Morgan, Seattle, WA (US)

(21) Appl. No.: 13/783,182

(22) Filed: Mar. 1, 2013

Related U.S. Application Data
(60) Provisional application No. 61/605,939, filed on Mar. 2, 2012.

(51) Int. Cl. B64D 11/00

(52) U.S. Cl. CPC B64D 11/003
USPC 428/35.7; 156/247; 428/34.1

(57) ABSTRACT

A temporary lining usable as a decorative protective guard on stowage bins on aircraft, such as passenger stowage bins on commercial aircraft. The temporary lining can have a protective layer, and an adhesive layer bonded to the protective layer. The temporary liner can be adhered to the interior of the stowage bins, and can be removed and replaced when damaged.

### BACKGROUND

1. Field of the Disclosure

The present disclosure relates to linings, and more particularly, to temporary linings used to protect stowage bins on aircraft.

2. Description of Related Art

Stowage bins on aircraft, such as commercial aircraft, can experience high volume use and can quickly be damaged or otherwise have poor appearance due to wear and tear. Maintenance of stowage bin interiors in aircraft can commonly require that the aircraft be taken out of service and transported to an MRO center. Thereafter, bin doors and hardware are typically removed and the inside of the aircraft is fully masked. Fiberglass repairs then ensue to fix holes and panel punctures and filler is applied and sanded to accept primer coats. Primer and paint are then applied involving VOCs. Also, a final decorative texture paint is applied over base coatings, and the interior must be reassembled, cleaned and returned to service. This process can add significant weight to the aircraft in each painting cycle. In short, current maintenance and repair procedures to stowage bin interiors is laborious, expensive and can be hazardous.

### BRIEF SUMMARY OF THE DISCLOSURE

Some embodiments of the present disclosure include an aircraft having passenger stowage bins with interior surfaces guarded by a temporary lining, the temporary lining having an adhesive surface and a protective surface. The adhesive surface is adhered to the interior of the passenger stowage bin. The adhesive on the adhesive surface forms a bond with the interior of the stowage bin that is sufficiently strong to hold the temporary lining in place during service, but the bond can be broken to remove the temporary lining from the stowage bin with relative ease.

In some embodiments, the temporary lining comprises a protective layer or film, having the protective surface, and an adhesive layer (e.g., a film) bonded to the protective layer, the adhesive layer also having the adhesive surface facing opposite the protective surface (e.g., a double sided adhesive film or layer).

Prior to installation of the temporary lining in stowage bins, the temporary lining can comprise a sacrificial liner, temporarily attached to the adhesive surface, which can be peeled away from the adhesive surface before adhering the adhesive surface to the interior of the passenger stowage bin. As such, in some embodiments, the temporary lining can be provided in ready-to-use form with the protective layer and adhesive layer sandwiched between the protective layer and sacrificial film.

In some embodiments, the protective layer is a vinyl film. The protective layer can be reverse printed to a customer specification. Also, a custom color can been compounded into the protective layer.

The adhesive of the adhesive layer can be a water-based adhesive, as will be appreciated by those skilled in the art after reviewing this disclosure.

### BRIEF DESCRIPTION OF THE DRAWINGS

FIG. 1 is a simplified view of a section of an embodiment of the temporary lining of the present disclosure, with a sacrificial liner being partially peeled away from the temporary lining.

FIG. 2 is a picture of a typical stowage bin interior with the temporary lining installed.

### DETAILED DESCRIPTION

In the following description, certain specific details are set forth in order to provide a thorough understanding of various embodiments of the disclosure. However, upon reviewing this disclosure, one skilled in the art will understand that the disclosure may be practiced without many of these details. In other instances, well-known structures related to aircraft, stowage bin structure, vinyl, other materials and adhesives, have not been described in detail to avoid unnecessarily obscuring the descriptions of the embodiments of the disclosure.

Various aspects of the present disclosure are described in the context of application to aircraft stowage bins, and typically fiberglass or decorative substrates. However, as will be appreciated by those skilled in the art after reviewing this disclosure, the temporary lining of the present disclosure can be applied in other applications. Examples include other parts of aircraft, such as other interior walls, or on surfaces outside of the aircraft industry, such as, for example, in other transportation vehicles where high traffic use is anticipated.

In the present description, the term “about” and its equivalents, mean ±20% of the indicated range, value, or structure, unless otherwise indicated. It should be understood that the terms “a” and “an” as used herein refer to “one or more” of the enumerated components. The use of the alternative (e.g., “or”) should be understood to mean either one, both, or any combination thereof of the alternatives. As used herein, the terms “include” and “comprise” are used synonymously, which terms and variants thereof are intended to be construed as non-limiting.

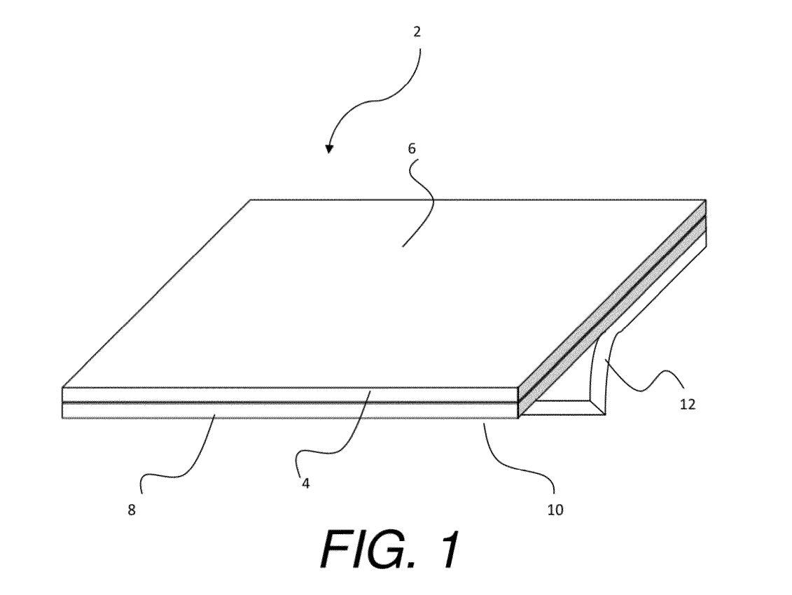

FIG. 1 shows an embodiment of a temporary lining 2 of the present disclosure. The temporary lining can comprise a protective layer 4 (e.g., vinyl film) that can be reverse printed to customer specifications. Also, in some embodiments, custom color can be compounded into the vinyl film for solid color applications, as will be appreciated by those skilled in art upon reviewing this disclosure. Also, in some embodiments, an additional protective layer 6 or film can be attached to the protective layer 4 (such as, for example, PTFE, or TEFLON®, or other type of resilient strengthening layer).

In some embodiments, an adhesive layer 8 (e.g., adhesive film) is provided as part of the temporary lining 2. The adhesive layer 8 can be double-sided, with one side bonded to the protective layer. The side facing opposite the protective layer, the “adhering surface” 10, can be applied to the interior of a stowage bin to adhere the protective layer to the stowage bin interior wall (or fiberglass or decorative substrate). In some embodiments, the adhering surface is provided in “peel and stick” form, wherein a sacrificial liner 12 is temporarily adhered to the adhering surface 10, and can be easily peeled off before application, as will be appreciated by those skilled in the art after reviewing the present disclosure.

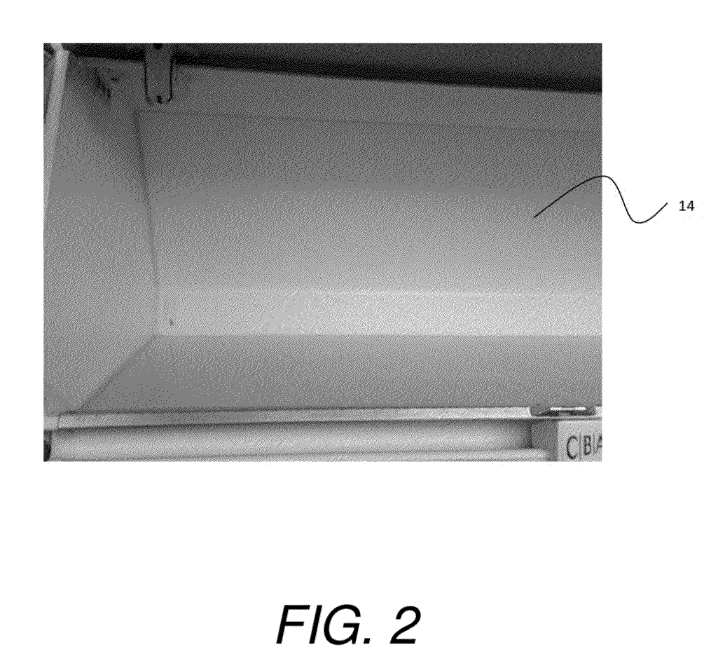

A user can measure and cut the temporary lining 2 as necessary to fit the application. Then the sacrificial liner 12 can be peeled away to apply the temporary lining 2 to the stowage bin 14, as shown in FIG. 2. The temporary lining 2 can improve the appearance and maintenance of passenger stowage bins, and provide an abrasion resistant surface on the inside of the stowage bins. The temporary lining 2 can stay in service until time for replacement. Experimental data has shown that the temporary lining 2 can increase surface damage resistance to the original surface of the interior of the stowage bins.

In some embodiments, the adhesive (which can be water-based) of the adhering surface 10 adheres to the stowage bin interior, but can be formulated to allow the temporary lining 2 to be peeled away from the stowage bin interior for replacement, as will be appreciated by those skilled in the art after reviewing this disclosure. Replacement can be made when the temporary lining 2 becomes damaged. However, the temporary lining is anticipated to be in service longer than paint in the same service, based on experimental data. Furthermore, in some embodiments, the temporary lining 2 can be installed in small sections, with the size depending on user selection. For example, without limitation, a user could install the temporary lining 2 on the stowage bin interiors in sizes of about 6 inch by 6 inch patches. Smaller patches can allow small sections to be replaced easily, by peeling away the section of temporary lining 2, and adhering another one in its place.

Furthermore, in some embodiments, the adhesive used on the adhesive layer 8 and adhering surface 10, is water-based, as will be appreciated by those skilled in the art, and installation of the temporary lining 2 is not hazardous, since there are no solvents, fillers or catalyzed paints involved in installation. As such, preparation work required for painting is eliminated, and installation time for the temporary lining in, for example, a BOEING 737-800 commercial jet can require as little as six (6) hours based on experience.

As will be appreciated by those skilled in the art, the adhesive can be formulated to provide a generally residue free removal of the temporary lining 2, and yet be strong enough to hold the temporary lining in place. Also, the temporary lining 2 as applied can have a lower specific gravity than paint typically applied to repair/maintain stowage bins, such that weight reduction can be realized by use of the temporary lining 2 in lieu of paint.

Although specific embodiments and examples of the disclosure have been described supra for illustrative purposes, various equivalent modifications can be made without departing from the spirit and scope of the disclosure, as will be recognized by those skilled in the relevant art after reviewing the present disclosure. The various embodiments described can be combined to provide further embodiments. The described devices and methods can omit some elements or acts, can add other elements or acts, or can combine the elements or execute the acts in a different order than that illustrated, to achieve various advantages of the disclosure. These and other changes can be made to the disclosure in light of the above detailed description.

In general, in the following claims, the terms used should not be construed to limit the claimed invention(s) to the specific embodiments disclosed in the specification. Accordingly, the scope of invention is determined entirely by the following claims.

What is claimed is:

1. A method for maintaining an aircraft stowage bin comprising:
providing a temporary lining having an adhesive surface and a protective surface;
adhering the adhesive surface to the interior of the aircraft stowage bin in sections to guard the aircraft stowage bin with the protective surface; and
removing the temporary lining when it is damaged and replacing it with another section of temporary lining, wherein the adhesive permits the temporary lining to be removed by being lifted away from the interior surface of the stowage bin.

2. The method of claim 1 wherein the temporary lining comprises a protective layer, having the protective surface, and an adhesive layer bonded to the protective layer, the adhesive layer having the adhesive surface facing opposite the protective surface.

3. The method of claim 2 wherein the temporary lining further comprises a sacrificial liner, temporarily attached to the adhesive surface, which can be peeled away from the adhesive surface before adhering the adhesive surface to the interior of the aircraft stowage bin.

4. The method of claim 2 wherein the protective layer is a vinyl film.

5. The method of claim 2 wherein the protective layer is reverse printed to a customer specification.

6. The method of claim 2 wherein a custom color has been compounded into the protective layer.

7. The method of claim 2 wherein an adhesive of the adhesive layer is water-based.

8. The method of claim 1 wherein the temporary lining is adhered to the stowage bin in a plurality of sections, whereby a single section can be removed and replaced when repairing localized damage.

9. An aircraft comprising:
a passenger stowage bin having an interior surface guarded by a temporary lining, the temporary lining having an adhesive surface and a protective surface;
wherein the adhesive surface is adhered to the interior of the passenger stowage bin; and
wherein an adhesive of the adhesive surface forms a bond with the interior of the stowage bin that is sufficiently strong to hold the temporary lining in place during service, but the bond can be manually broken to remove the temporary lining from the stowage bin.

10. The aircraft of claim 9 wherein the temporary lining comprises a protective layer, having the protective surface, and an adhesive layer bonded to the protective layer, the adhesive layer having the adhesive surface facing opposite the protective surface.

11. The aircraft of claim 10 wherein prior to installation of the temporary lining in the stowage bin, the temporary lining comprises a sacrificial liner, temporarily attached to the adhesive surface, which can be peeled away from the adhesive surface before adhering the adhesive surface to the interior of the passenger stowage bin.

12. The aircraft of claim 10 wherein the protective layer is a vinyl film.

13. The aircraft of claim 10 wherein the protective layer is reverse printed to a customer specification.

14. The aircraft of claim 10 wherein a custom color has been compounded into the protective layer.

15. The aircraft of claim 10 wherein an adhesive of the adhesive layer is water-based.

16. The aircraft of claim 9 wherein the temporary lining is adhered to the stowage bin in a plurality of sections, whereby a single section can be removed and replaced when repairing localized damage.
